(19) United States
(12) Patent Application Publication
(10) Pub. No.: US 2018/0209589 A1
(43) Pub. Date: Jul. 26, 2018

(54) HIGH-PRESSURE CONTAINER

(71) Applicant: TOYOTA JIDOSHA KABUSHIKI KAISHA, Toyota-shi (JP)

(72) Inventor: Osamu SAWAI, Okazaki-shi (JP)

(73) Assignee: TOYOTA JIDOSHA KABUSHIKI KAISHA, Toyota-shi (JP)

(21) Appl. No.: 15/875,116

(22) Filed: Jan. 19, 2018

(30) Foreign Application Priority Data
Jan. 24, 2017 (JP) 2017-010306

(51) Int. Cl. F17C 13/06; F17C 1/02

(52) U.S. Cl. CPC F17C 13/06; F17C 1/02; F17C 2201/0109; F17C 2221/012; F17C 2203/011; F17C 2203/0619; F17C 2203/0673; F17C 2270/0184

(57) ABSTRACT

A high-pressure container includes a body part having a cylindrical shape and including an opening at at least one of axially opposite end portions thereof, a cap that closes the opening of the body part and is displaceable in an axial direction of the body part, and a seal member provided between the body part and the cap, and the seal member provides a seal between the body part and the cap displaced relative to the body part.

### INCORPORATION BY REFERENCE

The disclosure of Japanese Patent Application No. 2017-010306 filed on Jan. 24, 2017 including the specification, drawings and abstract is incorporated herein by reference in its entirety.

### BACKGROUND

### 1. Technical Field

The disclosure relates to a high-pressure container.

### 2. Description of Related Art

A high-pressure hydrogen tank is disclosed in Japanese Patent Application Publication No. 2002-188794 (JP 2002-188794 A). The high-pressure hydrogen tank includes a liner formed in the shape of a barrel, and a reinforcement layer wound around the liner and formed of fiber reinforced resin. With this arrangement, the rigidity of the liner is increased, so that high-pressure hydrogen can be stored within the tank.

### SUMMARY

Since the high-pressure hydrogen tank disclosed in JP 2002-188794 A is formed in the shape of a barrel, the internal pressure is applied from hydrogen in the high-pressure tank to end portions of the liner in the longitudinal direction (axial direction). Therefore, the reinforcement layer needs to be also provided on the axial end portions of the liner so as to withstand the internal pressure. In this case, there is a need to wind a certain number of reinforcement layers in each of different directions, i.e., the circumferential direction of the liner and the axial direction of the liner, during production of the tank, so as to secure required rigidity. Accordingly, the number of process steps may be increased, and there is some room for improvement in this point, in the related art.

The disclosure provides a high-pressure container that can reduce the number of process steps at the time of production thereof.

A high-pressure container according to one aspect of the disclosure includes a body part having a cylindrical shape and including an opening at at least one of axially opposite end portions thereof, a cap that closes the opening of the body part and is displaceable in an axial direction of the body part, and a seal member provided between the body part and the cap. The seal member provides a seal between the body part and the cap displaced relative to the body part.

In the high-pressure container according to the above aspect of the disclosure, the cap is provided for closing the opening at at least one of the axially opposite end portions of the body part formed in a cylindrical shape, such that the cap is displaceable in the axial direction of the body part (which will be simply referred to as “axial direction”). The seal member is provided between the cap and the body part. The seal member provides a seal between the body part and the cap that is displaced relative to the body part. Accordingly, when the pressure of fluid stored within the body part increases, the cap can be displaced outward in the axial direction, without permitting the fluid to leak through between the body part and the cap. With the cap thus displaced axially outward, force produced by the pressure applied in the axial direction of the body part can be suppressed or reduced; therefore, reinforcement of the body part in the axial direction can be reduced. Thus, the high-pressure container as described above has an excellent effect that the number of process steps at the time of production of the container can be reduced.

In the high-pressure container according to the above aspect, a reinforcement material may be wound in the axial direction of the body part, on the body part and the cap, and the reinforcement material may be configured to elastically follow the cap when the cap is displaced.

In the high-pressure container as described above, the reinforcement material is wound in the axial direction, on the body part and the cap. Accordingly, proof strength against the pressure applied in the axial direction of the body part can be enhanced. Also, the reinforcement material is configured to elastically follow the cap when it is displaced. Accordingly, after the cap is displaced axially outward due to increase of the pressure of the fluid stored within the body part, the cap can be displaced axially inward so as to return to the original position when the pressure of the fluid is reduced. Thus, the high-pressure container as described above has an excellent effect that displacement of the cap can be stabilized.

The high-pressure container as described above may include a plurality of body parts arranged side by side, and each of the plurality of body parts may be the above-indicated body part. In the high-pressure container, the cap may close the openings of the plurality of body parts as a unit, and a communication channel that communicates interiors of the plurality of body parts with each other may be provided inside the cap.

With the above arrangement, the fluid within each of the plurality of body parts can be moved into other body part(s), so that the pressures of the fluid within the plurality of body parts are homogenized or made substantially equal to each other. Thus, the high-pressure container as described above has an excellent effect that variations in the pressure of the fluid applied from the two or more body parts to the cap, among the plurality of body parts, can be reduced.

In the high-pressure container as described above, the seal member may have an annular shape, and may include a first contact wall portion having an outside surface that is in abutting contact with an inner wall of the body part, and a second contact wall portion that is opposed to the first contact wall portion and has an inside surface that is in abutting contact with a side wall of the cap. The seal member may have a generally U-shaped cross-section that is open inward in the axial direction of the body part, in a plane perpendicular to a circumferential direction of the seal member.

With the above arrangement, when the pressure of the fluid within the body part increases, the fluid acts to press the first contact wall portion of the seal member against the inner wall of the body part, and also press the second contact wall portion against the side wall of the cap. Thus, even when the pressure of the fluid in the body part becomes high, and the cap is displaced, the fluid can be inhibited from leaking through between the body part and the cap. Thus, the high-pressure container as described above has an excellent effect that the fluid can be stored under a higher pressure in the container.

In the high-pressure container as described above, the seal member may be provided with a biasing member configured to bias the first contact wall portion toward the inner wall of the body part, and bias the second contact wall portion toward the side wall of the cap.

With the above arrangement, the outside surface of the first contact wall portion is kept in abutting contact with the inner wall of the body part, and the inside surface of the second contact wall portion is kept in abutting contact with the side wall of the cap. Namely, it is possible to stably maintain a sealed state between the body part and the cap, irrespective of variations in the pressure within the body part. Thus, the high-pressure container as described above has an excellent effect that the fluid can be inhibited from leaking through between the body part and the cap, irrespective of variations in the pressure within the high-pressure container.

In the high-pressure container as described above, the cap may include a body-part inserted portion generally in the shape of a column that protrudes inward in the axial direction of the body part, and a cutout portion may be provided at an outer edge of a distal end portion of the body-part inserted portion. The seal member may be received in the cutout portion.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an enlarged cross-sectional view showing a principal part of a high-pressure container according to one embodiment, in a condition where it is cut along an axial direction, as viewed from one side of a vehicle; and

FIG. 2 is an enlarged cross-sectional view showing a condition taken along line II-II in FIG. 1.

### DETAILED DESCRIPTION OF EMBODIMENTS

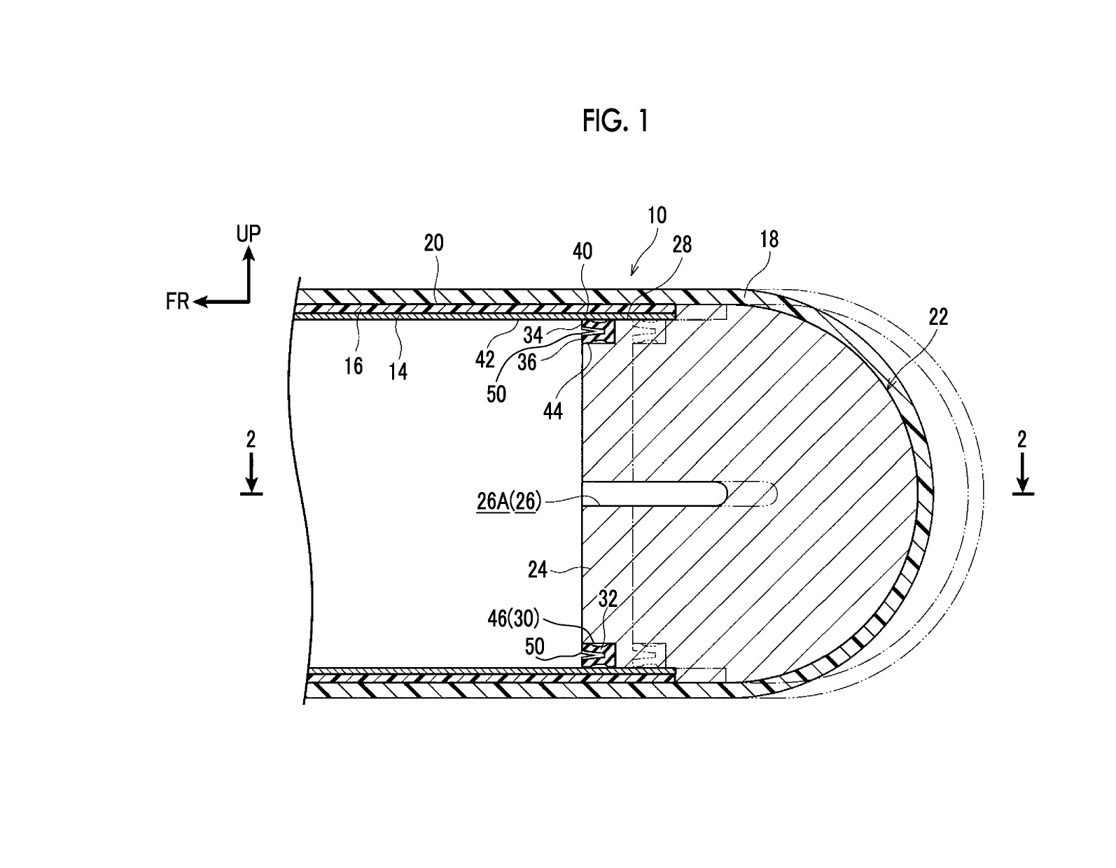

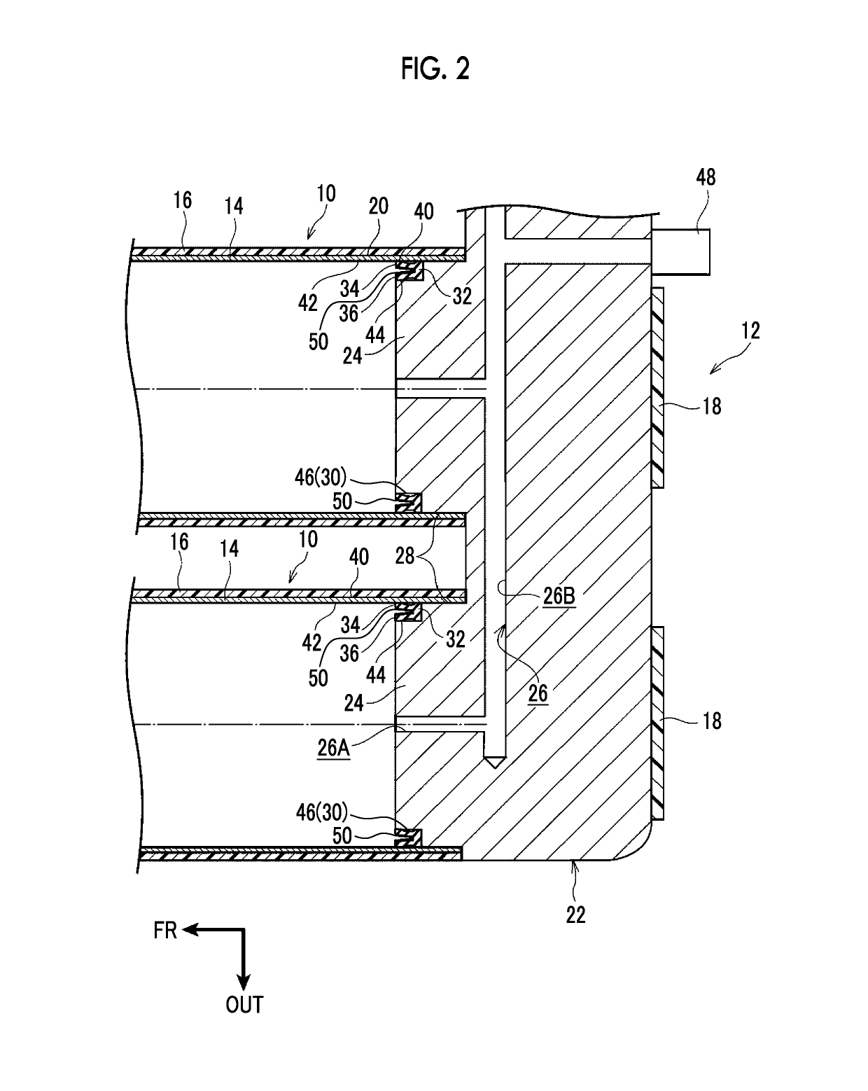

Referring to FIG. 1 and FIG. 2, a high-pressure container according to one embodiment of the disclosure will be described. In the drawings, arrow FR denotes the front side in the vehicle longitudinal direction, and arrow OUT denotes the outer side in the vehicle width direction, while UP denotes the upper side in the vehicle vertical direction.

As shown in FIG. 2, a tank module 12 is provided by assembling a plurality of tank bodies 10 together. The tank module 12 is located on the vehicle lower side of a floor panel (not shown) of a fuel cell vehicle, as one example.

Each of the tank bodies 10 is formed in a generally cylindrical shape having an axial direction (longitudinal direction) corresponding to the vehicle longitudinal or front-back direction, for example. The tank body 10 includes a body part 14, a first fiber reinforced resin member 16, and a second fiber reinforced resin member 18 as a reinforcement material. The body part 14 is formed in a cylindrical shape, and is open at its axially opposite end portions. The body part 14 is formed of aluminum alloy, as one example. The diameter of the body part 14 is determined such that it can be accommodated in space available on the vehicle lower side of the floor panel.

The first fiber reinforced resin member 16 is formed by winding a sheet-like CFRP (carbon fiber reinforced resin) on an outer circumferential surface 20 of the body part 14. In the interior of the first fiber reinforced resin member 16, carbon fibers (not shown) are arranged in the circumferential direction of the body part 14. In other words, the fiber direction of the first fiber reinforced resin member 16 is the circumferential direction of the body part 14.

A plurality of body parts 14 of the tank bodies 10 on which the first fiber reinforced resin members 16 are wound are arranged side by side in the vehicle width direction. End portions of the body parts 14 of the tank bodies 10 on one side in the axial direction are located at substantially the same position in the vehicle longitudinal direction. A cap 22 is inserted into the end portions of the body parts 14 on one side in the axial direction. The cap 22 is movable relative to the body parts 14 in the axial direction. Although not illustrated in the drawings, like the above-indicated end portions of the body parts 14 on one side in the axial direction, end portions of the body parts 14 of the tank bodies 10 on the other side in the axial direction are located at substantially the same position in the vehicle longitudinal direction, and a cap 22 is inserted into the end portions of the body parts 14 such that the cap 22 is movable relative to the body parts 14 in the axial direction.

As shown in FIG. 1, the cap 22 is formed generally in the shape of a semicircular column, which has an axial direction corresponding to the vehicle width direction, and is rounded outward in the axial direction of the body part 14. The cap 22 has body-part inserted portions 24, and a communication channel 26. The body-part inserted portions 24 are located at positions corresponding to the respective body parts 14 of the tank bodies 10, and each body-part inserted portion 24 is formed generally in the shape of a column that protrudes inward in the axial direction of the corresponding body part 14. A side wall 28 of the body-part inserted portion 24 is in abutting contact with an inner wall 42 of the body part 14. Also, a cutout portion 30, which is formed by cutting out an outer edge portion of each body-part inserted portion 24, is provided at a distal end portion of the body-part inserted portion 24, and a seal member 32 is received in the cutout portion 30.

The seal member 32 is formed in an annular shape having a center on the axis of the corresponding body part 14. More specifically, the seal member 32 includes a first contact wall portion 34 and a second contact wall portion 36. The first contact wall portion 34 extends generally in the axial direction. The second contact wall portion 36 is located on the inner side of the first contact wall portion 34 in radial directions of the body part 14, so as to be opposed to the first contact wall portion 34, and also extends in the axial direction. Then, an axially outer portion of the first contact wall portion 34 and an axially outer portion of the second contact wall portion 36 are connected to each other in the radial directions of the body part 14. Thus, the seal member 32 has a generally U-shaped cross section in a plane perpendicular to the circumferential direction, such that the U shape is open inward in the axial direction. An outside surface 40 of the first contact wall portion 34 is in abutting contact with the inner wall 42 of the body part 14, and an inside surface 44 of the second contact wall portion 36 is in abutting contact with a side wall 46 of the cutout portion 30 of the cap 22.

A spring 50 serving as a biasing member is provided inside the seal member 32. The spring 50, which may be a leaf spring as one example, biases the first contact wall portion 34 toward the inner wall 42 of the body part 14, and biases the second contact wall portion 36 toward the side wall 46 of the cap 22. Namely, with no regard to the pressure of fluid stored in the tank body 10, the outside surface 40 of the first contact wall portion 34 of the seal member 32 is kept in abutting contact with the inner wall 42 of the body part 14, and the inside surface 44 of the second contact wall portion 36 of the seal member 32 is kept in abutting contact with the side wall 46 of the cutout portion 30 of the cap 22.

The communication channel 26 is formed within the cap 22, and includes a plurality of first communication channels 26A and a second communication channel 26B (see FIG. 2). The first communication channels 26A extend within the respective body-part inserted portions 24 in the axial directions of the body parts 14, and are open inward in the axial directions. The second communication channel 26B connects the first communication channels 26A with each other in the vehicle width direction. With this arrangement, the interiors of the body parts 14 of the tank bodies 10 are in communication with each other.

The second fiber reinforced resin member 18 is provided on outer surfaces of the first fiber reinforced resin member 16 and the cap 22. More specifically, the second fiber reinforced resin member 18 is a sheet-like CFRP (carbon fiber reinforced resin) similar to the first fiber reinforced resin member 16, and the second fiber reinforced resin member 18 is integrally wound, in the axial direction of the body part 14, on the outer surfaces of the first fiber reinforced resin member 16 and the cap 22. In the interior of the second fiber reinforced resin member 18, carbon fibers (not shown) are arranged in the axial direction. In other words, the fiber direction of the second fiber reinforced resin member 18 is the axial direction of the body part 14. The amount of fibers in the second fiber reinforced resin member 18 is set to a half of the amount of fibers in the first fiber reinforced resin member 16. Also, the second fiber reinforced resin member 18 can elastically expand and contract to a certain extent along the axial direction.

The communication channel 26 in the cap 22 is provided with a valve 48 (see FIG. 2). The valve 48 makes it possible to control the amount of the fluid flowing in the communication channel 26. Then, the communication channel 26 is connected to a fuel cell stack, a supply pipe, or the like, which are not illustrated.

Next, the operation and effects of this embodiment will be described.

In this embodiment, as shown in FIG. 1, the body part 14 formed in a cylindrical shape is open at at least one of its axially opposite end portions, and the cap 22 is provided for closing the opening of the body part 14, such that the cap 22 can be displaced in the axial direction. The seal member 32 is provided between the cap 22 and the body part 14, and provides a seal between the body part 14, and the cap 22 displaced relative to the body part 14. Accordingly, when the pressure of the fluid stored within the body part 14 increases, the cap 22 can be displaced axially outward, without permitting the fluid to leak through between the body part 14 and the cap 22 (see two-dot chain lines in FIG. 1). With the cap 22 thus displaced axially outward, force produced by the pressure applied in the axial direction of the body part 14 can be suppressed or reduced; therefore, reinforcement in the axial direction of the body part 14 can be reduced. Consequently, the number of steps for providing reinforcement at the axial end portions of the body part 14 can be reduced, so that the number of process steps at the time of production of the high-pressure container can be reduced.

The second fiber reinforced resin member 18 is wound in the axial direction, on the body part 14 and the cap 22. Accordingly, the proof strength against the pressure applied in the axial direction of the body part can be enhanced. Also, the second fiber reinforced resin member 18 is configured to elastically follow the cap 22 when it is displaced. Accordingly, after the cap 22 is displaced axially outward due to increase of the pressure of the fluid stored within the body part 14, the cap 22 can be displaced axially inward so as to return to the original position when the pressure of the fluid is reduced. In this manner, displacement of the cap 22 can be stabilized.

Further, the two or more body parts 14 are arranged side by side, as shown in FIG. 2. Also, the cap 22 closes openings of the two or more body parts 14 as a unit, and the communication channel 26 that communicates the interiors of the body parts 14 with each other is formed within the cap 22. Accordingly, the fluid within each of the body parts 14 can be moved into other body parts 14; therefore, the pressures of the fluid within the body parts 14 can be homogenized or made substantially equal to each other. As a result, variations in the pressure of the fluid applied from the interiors of the two or more body parts 14 to the cap 22, among the body parts 14, can be reduced.

The seal member 32 is formed in an annular shape, and includes the first contact wall portion 34 having the outside surface 40 that is in abutting contact with the inner wall 42 of the body part 14, and the second contact wall portion 36 that is opposed to the first contact wall portion 34 and has the inside surface 44 that is in abutting contact with the side wall 46 of the cap 22. With the first and second contact wall portions 34, 36 thus provided, the seal member 32 has a generally U-shaped cross section in a plane perpendicular to the circumferential direction, such that the U shape is open inward in the axial direction. Accordingly, as the pressure of the fluid within the body part 14 increases, the fluid acts to press the first contact wall portion 34 of the seal member 32 against the inner wall 42 of the body part 14, and press the second contact wall portion 36 against the side wall 46 of the cap 22. Therefore, even when the pressure of the fluid within the body part 14 increases, and the cap 22 is displaced, the fluid is inhibited from leaking through between the body part 14 and the cap 22. Thus, fluid can be stored under a higher pressure in the body part 14.

Also, in the seal member 32, the spring 50 is provided for biasing the first contact wall portion 34 toward the inner wall 42 of the body part 14, and biasing the second contact wall portion 36 toward the side wall 46 of the cap 22. With the spring 50 thus provided, the outside surface 40 of the first contact wall portion 34 is kept in abutting contact with the inner wall 42 of the body part 14, and the inside surface 44 of the second contact wall portion 36 is kept in abutting contact with the side wall 46 of the cap 22. Namely, it is possible to stably maintain a sealed state between the body part 14 and the cap 22, irrespective of variations in the pressure within the body part 14. In this manner, the fluid can be inhibited from leaking through between the body part 14 and the cap 22, irrespective of variations in the pressure within the tank body 10.

In this embodiment, the body part 14 is open at its axially opposite end portions, and the caps 22 are inserted into one axial end portion and the other axial end portion of the body part 14, respectively. However, the disclosure is not limited to this arrangement, but only one of the axially opposite end portions of the body part 14 may have an opening, and the cap 22 may be inserted into the end portion having the opening.

While the second fiber reinforced resin member 18 is formed of CFRP in this embodiment, the material of the second fiber reinforced resin member 18 is not limited to this, but the second fiber reinforced resin member 18 may be formed from a resin member reinforced with fibers other than carbon fibers, or may be formed of a material other than resin.

While the spring 50 is provided inside the seal member 32 in this embodiment, the disclosure is not limited to this arrangement, but no spring may be provided.

While one embodiment of the disclosure has been described above, this disclosure is not limited to the above embodiment, but may be embodied with various modifications other than those as described above, without departing from the principle of the disclosure.

What is claimed is:

1. A high-pressure container comprising:
a body part having a cylindrical shape and including an opening at at least one of axially opposite end portions of the body part;
a cap that closes the opening of the body part, the cap being displaceable in an axial direction of the body part; and
a seal member provided between the body part and the cap, the seal member providing a seal between the body part and the cap displaced relative to the body part.

2. The high-pressure container according to claim 1, wherein a reinforcement material is wound in the axial direction of the body part, on the body part and the cap, and the reinforcement material is configured to elastically follow the cap when the cap is displaced.

3. The high-pressure container according to claim 1, comprising a plurality of body parts arranged side by side, each of the plurality of body parts being the body part, wherein
the cap closes the openings of the plurality of body parts as a unit, and a communication channel that communicates interiors of the plurality of body parts with each other is provided inside the cap.

4. The high-pressure container according to claim 1, wherein the seal member has an annular shape, and includes a first contact wall portion having an outside surface that is in abutting contact with an inner wall of the body part, and a second contact wall portion that is opposed to the first contact wall portion and has an inside surface that is in abutting contact with a side wall of the cap, the seal member having a generally U-shaped cross-section that is open inward in the axial direction of the body part, in a plane perpendicular to a circumferential direction of the seal member.

5. The high-pressure container according to claim 4, wherein the seal member is provided with a biasing member configured to bias the first contact wall portion toward the inner wall of the body part, and bias the second contact wall portion toward the side wall of the cap.

6. The high-pressure container according to claim 1, wherein:
the cap includes a body-part inserted portion generally in the shape of a column that protrudes inward in the axial direction of the body part, and a cutout portion is provided at an outer edge of a distal end portion of the body-part inserted portion; and
the seal member is received in the cutout portion.
